(19) United States
(12) Patent Application Publication
(10) Pub. No.: US 2026/0192824 A1
(43) Pub. Date: Jul. 9, 2026

(54) BEHAVIORAL MODELS FOR DRIVING SYSTEMS

(71) Applicant: QUALCOMM Incorporated, San Diego, CA (US)

(72) Inventors: Pranav DESAI, San Diego, CA (US); Ashish Biren MEHTA, Santa Clara, CA (US); Abhishek PERI, San Diego, CA (US); Vinay Kumar SENTHIL KUMAR, Philadelphia, PA (US); Monu SURANA, San Diego, CA (US); Richard Stephen SHAFFER, Jenkintown, PA (US); Reuben Manappallil Varghese JOHN, San Diego, CA (US); Chloe BENZ, San Diego, CA (US)

(21) Appl. No.: 19/437,075

(22) Filed: Dec. 30, 2025

Related U.S. Application Data
(60) Provisional application No. 63/741,780, filed on Jan. 3, 2025.

(51) Int. Cl. B60W 60/00; B60W 50/00; B60W 50/14; G06N 3/0455

(52) U.S. Cl. CPC B60W 60/0015; B60W 50/0097; B60W 50/14; B60W 60/00274; G06N 3/0455; B60W 2050/146; B60W 2554/4045; B60W 2556/40

(57) ABSTRACT

Systems and techniques are provided for improving driving systems. For example, a computing device can obtain environment data for a vehicle and can process the environment data using a first planning model and a second planning model (e.g., a trained planning model) to generate one or more first planning proposals and one or more second planning proposals, respectively, for the vehicle. The computing device can use an additional model to generate a first subset of planning proposals (from the one or more first planning proposals and the one or more second planning proposals) for the vehicle. The computing device can process the first subset of planning proposals using a safety verifier to generate a second subset of planning proposals including a navigation plan for the vehicle. The computing device can adjust a performance of the vehicle using the navigation plan.

### CROSS REFERENCE TO RELATED APPLICATIONS

The present application claims the benefit of U.S. Provisional Application No. 63/741,780, filed Jan. 3, 2025, the contents of which is incorporated herein for all purposes.

### FIELD

The present disclosure generally relates to systems for autonomous driving. For example, aspects of the present disclosure are related to improved machine learning systems for driving systems (e.g., semi-autonomous and/or autonomous driving systems).

### BACKGROUND

Increasingly, systems and devices (e.g., autonomous vehicles, such as autonomous and semi-autonomous cars, drones, mobile robots, mobile devices, extended reality (XR) devices, and other suitable systems or devices) include multiple sensors to gather information about the environment, as well as processing systems to process the information gathered, such as for route planning, navigation, collision avoidance, etc. One example of such a system is an Advanced Driver Assistance System (ADAS) for a vehicle.

Sensor data, such as frames (e.g., images) captured from one or more sensors, such as camera(s), radio detection and ranging (RADAR), light detection and ranging (LIDAR), etc., may be gathered, transformed, and analyzed to detect objects (e.g., targets). Detected objects may be compared to known objects to help determine what object is being tracked. Generally, ADAS systems may include one or more machine learning (ML) models that may be trained to perform driving tasks, such as localization of an ego device (e.g., an ego vehicle), path planning, determining a response for vulnerable road users (VRUs) (e.g., pedestrians, bicyclists, etc.).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In some aspects, an apparatus for autonomous driving is provided. The apparatus includes at least one memory and at least one processor coupled to the at least one memory and configured to: obtain environment data associated with an environment of a vehicle, the environment data including at least one of object data associated with one or more objects in the environment, map data associated with the environment, routing data associated with the environment, or one or more driving rules associated with the environment; process the environment data using a first planning model to generate one or more first planning proposals for the vehicle; process the environment data using a second planning model to generate one or more second planning proposals for the vehicle, the second planning model including a trained planning model; process the one or more first planning proposals and the one or more second planning proposals using a additional model to generate a first subset of planning proposals for the vehicle from the one or more first planning proposals and the one or more second planning proposals; process the first subset of planning proposals using a safety verifier to generate a second subset of planning proposals, wherein the second subset of planning proposals include a navigation plan for the vehicle; and adjust a performance of the vehicle using the navigation plan.

In some aspects, a method for autonomous driving is provided. The method includes: obtaining environment data associated with an environment of a vehicle, the environment data including at least one of object data associated with one or more objects in the environment, map data associated with the environment, routing data associated with the environment, or one or more driving rules associated with the environment; processing the environment data using a first planning model to generate one or more first planning proposals for the vehicle; processing the environment data using a second planning model to generate one or more second planning proposals for the vehicle, the second planning model including a trained planning model; processing the one or more first planning proposals and the one or more second planning proposals using a additional model to generate a first subset of planning proposals for the vehicle from the one or more first planning proposals and the one or more second planning proposals; processing the first subset of planning proposals using a safety verifier to generate a second subset of planning proposals, wherein the second subset of planning proposals include a navigation plan for the vehicle; and adjusting a performance of the vehicle using the navigation plan.

In some aspects, a non-transitory computer-readable medium is provided having stored thereon instructions that, when executed by at least one processor, cause the at least one processor to: obtain environment data associated with an environment of a vehicle, the environment data including at least one of object data associated with one or more objects in the environment, map data associated with the environment, routing data associated with the environment, or one or more driving rules associated with the environment; process the environment data using a first planning model to generate one or more first planning proposals for the vehicle; process the environment data using a second planning model to generate one or more second planning proposals for the vehicle, the second planning model including a trained planning model; process the one or more first planning proposals and the one or more second planning proposals using a additional model to generate a first subset of planning proposals for the vehicle from the one or more first planning proposals and the one or more second planning proposals; process the first subset of planning proposals using a safety verifier to generate a second subset of planning proposals, wherein the second subset of planning proposals include a navigation plan for the vehicle; and adjust a performance of the vehicle using the navigation plan.

In some aspects, an apparatus for autonomous driving is provided. The apparatus includes: means for obtaining environment data associated with an environment of a vehicle, the environment data including at least one of object data associated with one or more objects in the environment, map data associated with the environment, routing data associated with the environment, or one or more driving rules associated with the environment; means for processing the environment data using a first planning model to generate one or more first planning proposals for the vehicle; means for processing the environment data using a second planning model to generate one or more second planning proposals for the vehicle, the second planning model including a trained planning model; means for processing the one or more first planning proposals and the one or more second planning proposals using a additional model to generate a first subset of planning proposals for the vehicle from the one or more first planning proposals and the one or more second planning proposals; means for processing the first subset of planning proposals using a safety verifier to generate a second subset of planning proposals, wherein the second subset of planning proposals include a navigation plan for the vehicle; and means for adjusting a performance of the vehicle using the navigation plan.

In some aspects, one or more of the apparatuses described herein is, is part of, and/or includes a vehicle or a computing device or component of a vehicle. In some aspects, the apparatus(es) can include one or more sensors, such as one or more image sensors (e.g., cameras), LIDAR sensors, RADAR sensors, and/or other sensors for capturing sensor data (e.g., one or more images, LIDAR data, RADAR data, etc.). In some aspects, the apparatus(es) can include one or more other types of sensors, such as one or more inertial measurement units (IMUs), such as one or more gyroscopes, one or more gyrometers, one or more accelerometers, any combination thereof, and/or other sensor. In some aspects, the apparatus(es) can include one or more displays for displaying one or more images, notifications, navigation information, and/or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIGS. 1A and 1B are block diagrams illustrating a vehicle suitable for implementing various techniques described herein, in accordance with aspects of the present disclosure.

FIG. 1C is a block diagram illustrating components of a vehicle suitable for implementing various techniques described herein, in accordance with aspects of the present disclosure;

FIG. 1D illustrates an example implementation of a system-on-a-chip (SOC), in accordance with some examples;

FIG. 2 is a block diagram illustrating an example of an architecture for a planner system, in accordance with aspects of the present disclosure;

FIG. 3 is a block diagram illustrating a causal transformer backbone for a planner system, in accordance with aspects of the present disclosure;

FIG. 4 is a block diagram of a system illustrating autoregressive steps versus token space, in accordance with aspects of the present disclosure;

FIG. 5 is a block diagram illustrating a planner extension, in accordance with aspects of the present disclosure;

FIG. 6 is a block diagram illustrating an architecture of a planner system, in accordance with aspects of the present disclosure;

FIG. 7 is a diagram illustrating examples of systems for illustrating goal conditioning, in accordance with aspects of the present disclosure;

FIG. 8 is a diagram illustrating key-point and trajectory level clustering, in accordance with aspects of the present disclosure;

FIG. 9 is a diagram illustrating trajectory level tokenization, in accordance with aspects of the present disclosure;

FIG. 10 is a diagram illustrating key-point level tokenization, in accordance with aspects of the present disclosure;

FIG. 11 is a diagram illustrating scenes as a matrix and as a vector, in accordance with aspects of the present disclosure;

FIG. 12 is a block diagram illustrating an example of a deep learning neural network that can be used to implement a perception model and/or one or more validation models, according to some aspects of the disclosed technology;

FIG. 13 is a block diagram of an example transformer in accordance with some aspects of the disclosure;

FIG. 14 is a flow diagram of an example of a process for generating content in accordance with some aspects of the disclosure; and

FIG. 15 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. Various changes may be made in the function and arrangement of elements without departing from the spirit and scope of the application as set forth in the appended claims.

In some cases, an Advanced Driver Assistance System (ADAS) of a vehicle may use machine learning (ML) models to perform tasks to allow the vehicle to move through an environment. The quality of the ML models may vary based on the quality of data used to train the ML models. Using training data that accurately represents real-world scenarios may be useful for training. As an example, human factors, such as pedestrians or other vulnerable road users (VRUs), can be challenging for ADAS systems as VRUs can be behave in unpredictable ways, may be occluded, can appear in dense groups, etc. Additionally, VRUs can appear in many different combinations with other objects and/or condition, such as in the presence of other vehicles, occluded by an object, in a crosswalk, along the road, etc.

Systems, apparatuses, electronic devices, methods (also referred to as processes), and computer-readable media (collectively referred to herein as “systems and techniques”) are described herein for improved systems for driving control (e.g., semi-autonomous driving control, autonomous driving control, etc.). In particular, disclosed techniques involve performing prediction and planning operations simultaneously in an iterative manner, which can result in improved performance. The term autonomous as used herein (e.g., autonomous driving, autonomous vehicle, etc.) refers to any level of autonomy, including fully autonomous, semi-autonomous, or the like.

Various aspects of the application will be described with respect to the figures.

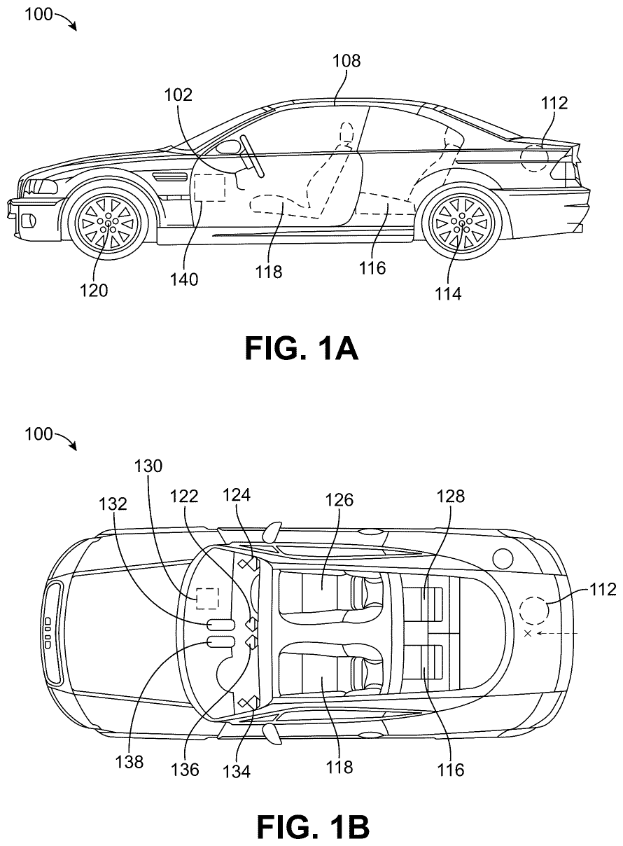

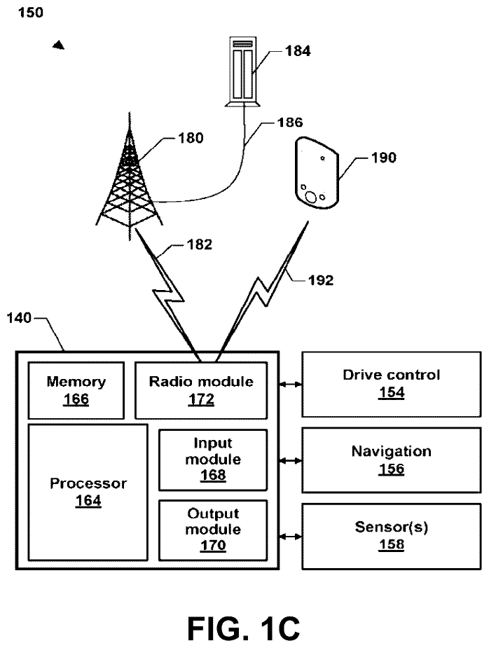

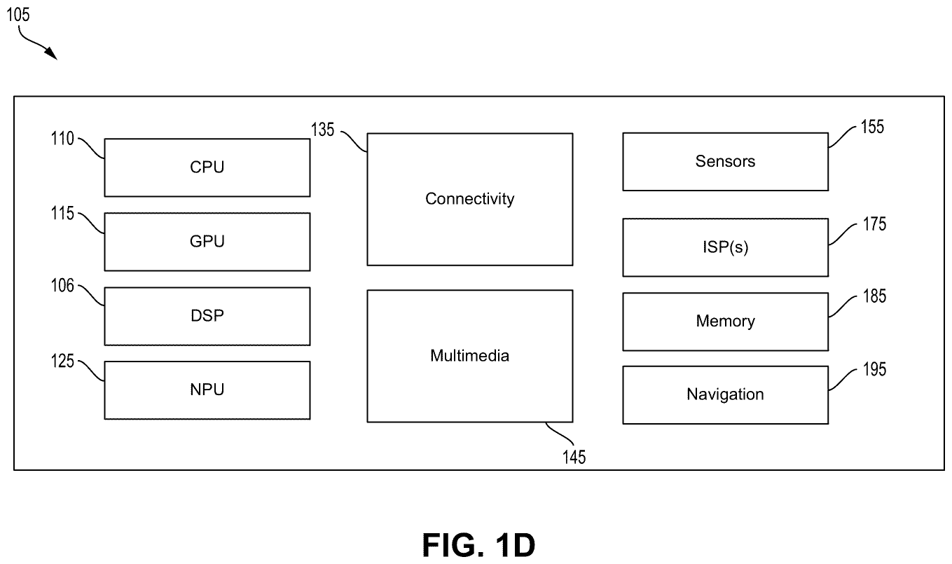

The systems and techniques described herein may be implemented by any type of system or device. One illustrative example of a system that can be used to implement the systems and techniques described herein is a vehicle (e.g., an autonomous or semi-autonomous vehicle) or a system or component (e.g., an ADAS, data collection system, or other system or component) of the vehicle. FIGS. 1A and 1B are diagrams illustrating an example vehicle 100 that may implement the systems and techniques described herein. With reference to FIGS. 1A and 1B, a vehicle 100 may include a control unit 140 and a plurality of sensors 102-138, including satellite geopositioning system receivers (e.g., sensors) 108, occupancy sensors 112, 116, 118, 126, 128, tire pressure sensors 114, 120, cameras 122, 136, microphones 124, 134, impact sensors 130, RADAR 132, and LIDAR 138. The plurality of sensors 102-138, disposed in or on the vehicle, may be used for various purposes, such as autonomous and semi-autonomous navigation and control, crash avoidance, position determination, etc., as well to provide sensor data regarding objects and people in or on the vehicle 100. The sensors 102-138 may include one or more of a wide variety of sensors capable of detecting a variety of information useful for navigation and collision avoidance. Each of the sensors 102-138 may be in wired or wireless communication with a control unit 140, as well as with each other. In particular, the sensors may include one or more cameras 122, 136 or other optical sensors or photo optic sensors. The sensors may further include other types of object detection and ranging sensors, such as RADAR 132, LIDAR 138, IR sensors, and ultrasonic sensors. The sensors may further include tire pressure sensors 114, 120, humidity sensors, temperature sensors, satellite geopositioning sensors 108, accelerometers, vibration sensors, gyroscopes, gravimeters, impact sensors 130, force meters, stress meters, strain sensors, fluid sensors, chemical sensors, gas content analyzers, pH sensors, radiation sensors, Geiger counters, neutron detectors, biological material sensors, microphones 124, 134, occupancy sensors 112, 116, 118, 126, 128, proximity sensors, and other sensors. Of note, while discussed in the context of a vehicle, aspects of the vehicle may be implemented as a data collection system for collecting information about the environment. The data collection system may be integrated with a vehicle, or logically separate from the vehicle (e.g., carried by (or affixed to) the vehicle).

The vehicle control unit 140 may be configured with processor-executable instructions to perform various aspects using information received from various sensors, particularly the cameras 122, 136, RADAR 132, and LIDAR 138. In some aspects, the control unit 140 may supplement the processing of camera images using distance and relative position information (e.g., relative bearing angle) that may be obtained from RADAR 132 and/or LIDAR 138 sensors. The control unit 140 may further be configured to control steering, breaking and speed of the vehicle 100 when operating in an autonomous or semi-autonomous mode using information regarding other vehicles determined using various aspects.

FIG. 1C is a component block diagram illustrating a system 150 of components and support systems suitable for implementing various aspects. With reference to FIGS. 1A, 1B, and 1C, a vehicle 100 may include a control unit 140, which may include various circuits and devices used to control the operation of the vehicle 100. In the example illustrated in FIG. 1C, the control unit 140 includes a processor 164, memory 166, an input model 168, an output model 170 and a radio model 172. The control unit 140 may be coupled to and configured to control drive control components 154, navigation components 156, and one or more sensors 158 of the vehicle 100.

The control unit 140 may include a processor 164 that may be configured with processor-executable instructions to control maneuvering, navigation, and/or other operations of the vehicle 100, including operations of various aspects. The processor 164 may be coupled to the memory 166. The control unit 140 may include the input model 168, the output model 170, and the radio model 172.

The radio model 172 may be configured for wireless communication. The radio model 172 may exchange signals 182 (e.g., command signals for controlling maneuvering, signals from navigation facilities, etc.) with a network node 180, and may provide the signals 182 to the processor 164 and/or the navigation components 156. In some aspects, the radio model 172 may enable the vehicle 100 to communicate with a wireless communication device 190 through a wireless communication link 92. The wireless communication link 92 may be a bidirectional or unidirectional communication link and may use one or more communication protocols.

The input model 168 may receive sensor data from one or more vehicle sensors 158 as well as electronic signals from other components, including the drive control components 154 and the navigation components 156. The output model 170 may be used to communicate with or activate various components of the vehicle 100, including the drive control components 154, the navigation components 156, and the sensor(s) 158.

The control unit 140 may be coupled to the drive control components 154 to control physical elements of the vehicle 100 related to maneuvering and navigation of the vehicle, such as the engine, motors, throttles, steering elements, other control elements, braking or deceleration elements, and the like. The drive control components 154 may also include components that control other devices of the vehicle, including environmental controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 140 may be coupled to the navigation components 156 and may receive data from the navigation components 156. The control unit 140 may be configured to use such data to determine the present position and orientation of the vehicle 100, as well as an appropriate course toward a destination. In various aspects, the navigation components 156 may include or be coupled to a global navigation satellite system (GNSS) receiver system (e.g., one or more Global Positioning System (GPS) receivers) enabling the vehicle 100 to determine its current position using GNSS signals. Alternatively, or in addition, the navigation components 156 may include radio navigation receivers for receiving navigation beacons or other signals from radio nodes, such as Wi-Fi access points, cellular network sites, radio station, remote computing devices, other vehicles, etc. Through control of the drive control components 154, the processor 164 may control the vehicle 100 to navigate and maneuver. The processor 164 and/or the navigation components 156 may be configured to communicate with a server 184 on a network 186 (e.g., the Internet) using wireless signals 182 exchanged over a cellular data network via network node 180 to receive commands to control maneuvering, receive data useful in navigation, provide real-time position reports, and assess other data.

The control unit 140 may be coupled to one or more sensors 158. The sensor(s) 158 may include the sensors 102-138 as described and may be configured to provide a variety of data to the processor 164 and/or the navigation components 156. For example, the control unit 140 may aggregate and/or process data from the sensors 158 to produce information the navigation components 156 may use for localization. As a more specific example, the control unit 140 may process images from multiple camera sensors to generate a single semantically segmented image for the navigation components 156. As another example, the control unit 140 may generate a frame of fused point clouds from LIDAR and RADAR data for the navigation components 156.

While the control unit 140 is described as including separate components, in some aspects some or all of the components (e.g., the processor 164, the memory 166, the input model 168, the output model 170, and the radio model 172) may be integrated in a single device or model, such as a system-on-chip (SOC) processing device. Such an SOC processing device may be configured for use in vehicles and be configured, such as with processor-executable instructions executing in the processor 164, to perform operations of various aspects when installed into a vehicle.

FIG. 1D illustrates an example implementation of a system-on-a-chip (SOC) 105, which may include a central processing unit (CPU) 110 or a multi-core CPU, configured to perform one or more of the functions described herein. In some cases, the SOC 105 may be based on an ARM instruction set. In some cases, CPU 110 may be similar to processor 164. Parameters or variables (e.g., neural signals and synaptic weights), system parameters associated with a computational device (e.g., neural network with weights), delays, frequency bin information, task information, among other information may be stored in a memory block associated with a neural processing unit (NPU) 125, in a memory block associated with a CPU 110, in a memory block associated with a graphics processing unit (GPU) 115, in a memory block associated with a digital signal processor (DSP) 106, in a memory block 185, and/or may be distributed across multiple blocks. Instructions executed at the CPU 110 may be loaded from a program memory associated with the CPU 110 or may be loaded from a memory block 185. In some cases, the SOC 105 may include a neural signal processor (NSP) that can process data according to aspects described herein.

The SOC 105 may also include additional processing blocks tailored to specific functions, such as a GPU 115, a DSP 106, a connectivity block 135, which may include fifth generation (5G) connectivity, fourth generation long term evolution (4G LTE) connectivity, Wi-Fi connectivity, USB connectivity, Bluetooth connectivity, and the like, and a multimedia processor 145 that may, for example, detect and recognize gestures. In one implementation, the NPU is implemented in the CPU 110, DSP 106, and/or GPU 115. The SOC 105 may also include a sensor processor 155, image signal processors (ISPs) 175, and/or navigation model 195, which may include a global positioning system. In some cases, the navigation model 195 may be similar to navigation components 156 and sensor processor 155 may accept input from, for example, one or more sensors 158. In some cases, the connectivity block 135 may be similar to the radio model 172.

In some cases, a vehicle, such as vehicle 100 in FIG. 1A and FIG. 1B, may collect information about the environment around the vehicle and stores the information for later use, such as for use as training data for ML models. In some cases, the information may also be processed by ML models, for example, to organize and/or categorize the information.

In some cases, sensor data, such as images captured by the image capture system, point clouds captured by LIDAR/RADAR sensors, etc., may be processed to use to train neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

Traditional driving systems use separate prediction and planning models that operate in series. For example, a prediction model of a vehicle (referred to as an ego vehicle) may receive environmental inputs such as information associated with objects (e.g., static and/or moving objects), one or more maps, one or more routes, and the vehicle (e.g., a pose of the vehicle, such as the orientation and/or position/location of the vehicle). Additional inputs are possible. In some cases, the information associated with the objects include a list of objects in a scene or environment of the vehicle at a given point in time. The information associated with the map may be a sliced map (e.g., including a certain range of area in the scene or environment). The information associated with the vehicle (e.g., the ego vehicle) may include pose (e.g., position and orientation) information of the vehicle with respect to the map. The vehicle (e.g., the ego vehicle) can be an autonomous or semi-autonomous vehicle including sensors (e.g., one or more image sensors such as camera(s), one or more RADAR sensors, one or more LIDAR sensors, etc.) that can capture sensor data used to perceive the scene or environment around the vehicle. A role of the prediction block is to predict events (e.g., intentions and/or trajectories) given the input data. For instance, based on processing the environmental inputs, the prediction model can output intentions and trajectories. Each intention and trajectory may correspond to a particular object. In one illustrative example, another vehicle positioned in front of the vehicle may be predicted to cut into a driving lane in front of the vehicle.

The prediction block can receive and process the output from the prediction model (e.g., the intentions and/or trajectories) and in some cases the environmental inputs to generate a navigation plan (also referred to as an ego plan) for the vehicle. In some aspects, the navigation/ego plan can include a proposed trajectory of the vehicle.

In some cases, such traditional driving systems using separate prediction and planning models can be inadequate in certain driving domains, such as driving domains that involve complex interactions, negotiations, and intricate geometries (e.g., urban or city geometries). For example, to navigate complex interactive environments, the vehicle stack (e.g., autonomous or semi-autonomous vehicle stack) may need to comprehend the negotiating behaviors of other agents (e.g., vehicles, vulnerable road users (VRUs), etc.), diverse map elements, and country-specific road rules such as yielding or right of way. This understanding is helpful for devising an effective ego plan that is not only safe but also human-like and natural, allowing for seamless coexistence with human drivers. Use of the above-described traditional driving systems can lead to suboptimal decisions and assumptions. For example, when the prediction and planning models operate independently, the planning model (also referred to as a planner or planner system) cannot fully utilize the predictive insights as plans may evolve temporally, while prediction does not account for the constraints and goals of the planning model. The separation of the prediction and planning models can also result in less efficient and less accurate decision-making processes. In some cases, predictions of other agents are performed in an open loop manner, and do not account for actions (or predicted actions) of the ego vehicle.

Existing driving systems may also require complex interfaces. The interface between prediction and planning, which involves sharing intentions or trajectories, is inherently complex. This complexity arises because planning horizons are often multiple seconds and in interactive scenarios where interaction happens during the planning horizon, it may make the original predictions useless or inaccurate. In general, the interface may be lossy and may constantly evolve to adapt to new scenarios and constraints, which can make it difficult to maintain consistency and reliability. Existing solutions may also use computationally expensive approaches. An action-conditioned prediction model may be needed for a planner to explore various actions. For example, the prediction model may need to generate forecasts based on different potential actions the planner may take. Such a process is computationally expensive because it involves running multiple simulations and evaluations, which can be resource-intensive and time-consuming.

In some examples, existing driving systems may not scale well and may not be generalizable. For example, the modular approach of using separate prediction and planning models may face challenges in generalizing and scaling. As the system encounters more diverse and complex scenarios, the modular approach may struggle to adapt in an efficient manner. For example, both of the prediction and planning models may need to be individually scaled and optimized, which can be difficult to manage and integrate seamlessly.

The systems and techniques described herein provide improved driving systems (e.g., semi-autonomous and/or autonomous driving systems) for driving control. As described in more detail herein, the systems and techniques can perform prediction and planning operations simultaneously in an iterative manner. The systems and techniques can overcome the above-noted challenges of existing driving systems using a learning-based approach that establishes a foundational behavioral model for driving systems.

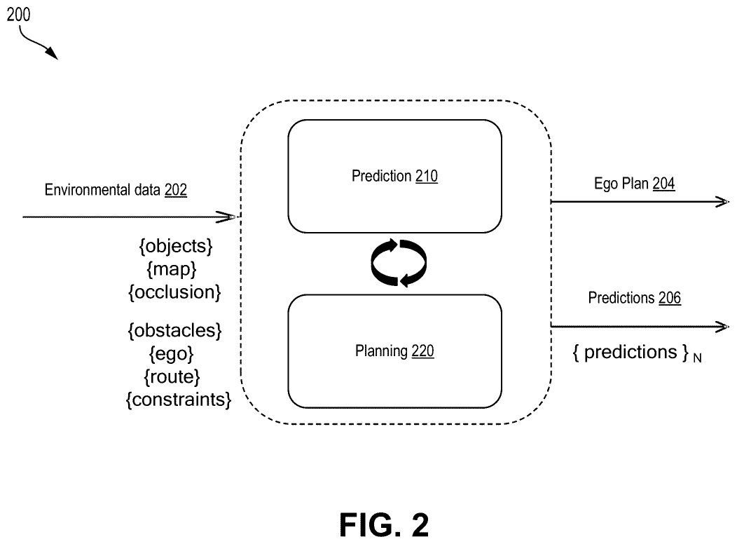

FIG. 2 is a block diagram illustrating an example of an architecture of a planner system 200 of a vehicle (e.g., an ego vehicle), in accordance with aspects of the present disclosure. As shown, the system 200 includes a prediction model 210 and a planning model 220. The prediction model and the planning model can be machine learning models (e.g., neural network models), as described herein. In the example depicted, prediction model 210 and planning model 220 receive environmental data 202 and generate an ego plan 204 and/or predictions 206.

As shown, the prediction model 210 and the planning model 220 can each receive as input environmental data 202, which may include information associated with an environment of the vehicle. For example, the environmental data 202 can include object data associated with one or more objects (e.g., static or moving objects, such as cars, obstacles, VRUs, etc.) in the environment, map data associated with one or more maps of the environment, vehicle data associated with the vehicle (e.g., a pose of the vehicle, such as the orientation and/or position/location of the vehicle), routing data associated with one or more routes through the environment, constraint data associated with one or more constraints associated with the environment and/or the vehicle, any combination thereof, and/or other environment data. In some cases, the environmental data 202 may also include one or more driving rules associated with the environment, such as country-specific driving rules (e.g., rules relating to yielding to oncoming traffic, 4-way stop behaviors, etc.).

The prediction model 210 and the planning model 220 may then iteratively process the environmental data 202, causing the system to output predictions and a navigation plan (e.g., ego plan) for the vehicle. Relative to existing driving system solutions, the prediction and planning operations of the system 200 take place simultaneously in an iterative manner. Further, the output predictions are not only based on the histories of other agents, but also future predictions of agents and/or predictions of the vehicle.

In some aspects, the system 200 can learn a compressed representation of the world (e.g., the environment around the vehicle), such as road graph geometry and topology, complex agent behaviors such as negotiation, yielding, and slowing down for vulnerable road users (VRUs), etc. The system 200 can generate a human-like, naturalistic navigation plan for the ego vehicle.

The system 200 provides a data-driven framework that can inherently learn a prediction model conditioned on actions of the ego vehicle. The system 200 is scalable and can generalize with data over time without additional modes or heuristics. In some aspects, the system 200 can learn complex human-like behaviors. For example, the system 200 can learn complex behaviors such as lateral negotiation for parked cars or yielding to pedestrians without explicit rules. In some cases, computational operations can be distributed across processing devices, such as CPU, GPU, DSP, NPU, NSP, etc. As described in more detail herein, such distributed processing can increase compute efficiency of the system 200.

The system 200 can ensure performance, integration, and coexistence with traditional vehicle stacks (e.g., autonomous or semi-autonomous vehicle stacks), which may have strict bounds and requirements with respect to safety, uncertainty, and real-time compute. For example, the system 200 can integrate seamlessly with traditional vehicle stacks to ensure safety, to provide adherence to traffic regulations, and to provide a robust driver-human interface (HMI). The hybrid approach provided by the system 200, which can evaluate both traditional and AI/ML-based planning proposals, can be crucial for handling out-of-distribution scenarios in ML models, providing a safe fallback in some cases, and offering valuable feedback for active-learning ML pipelines.

In some aspects, the system 200 can use a goal representation, which can serve as an interface to control and guide the behavioral model, offering a simple and scalable representation of routes, traffic lights, country-specific road rules (e.g., yield, 4-way stop behaviors, etc.), among other representations. The goal representation can ensure compliance with various road regulations and traffic patterns, providing a straightforward abstraction for the planner system 200.

In some cases, the system 200 can use a cost selection model. The cost selection model can play a crucial role in ensuring the optimal performance and safety of the system 200, such as by comparing the trajectories generated by the planner system 200 with those from a traditional planner system (e.g., the traditional planner system described above that uses separate prediction and planning models). Selection criteria used by the cost selection model can include various metrics, such as safety, compliance with road rules, preference, overall feasibility, among others.

In some aspects, the system 200 can use efficient ego-centric tokenization strategies to enhance generalization and in-distribution trajectory generation. For example, selecting a subset of tokens (e.g., top-K tokens) for generation based on safety, map priors, or constraints can provide controllability and an opportunity to inject bias/priors during the trajectory generation process.

The architecture of the system 200 is designed to be flexible and scalable, such that each of the components can be replaced or upgraded as needed. Such a flexible and scalable design can allow the system 200 to support multiple neural network backbones, such as autoregressive neural network models, diffusion models, state-space models, or mixture of experts (MoE)-based backbones, and/or other types of backbones.

Training objectives for training the system 200 can be selected for various purposes, such as to ensure self-supervised pretraining with unlabeled data, enabling scalability to large datasets. Such training objectives can be important because annotation and labeling of training datasets can be expensive. Further, pretraining can provide the model of the system 200 with an understanding of traffic interactions and the behaviors of other agents.

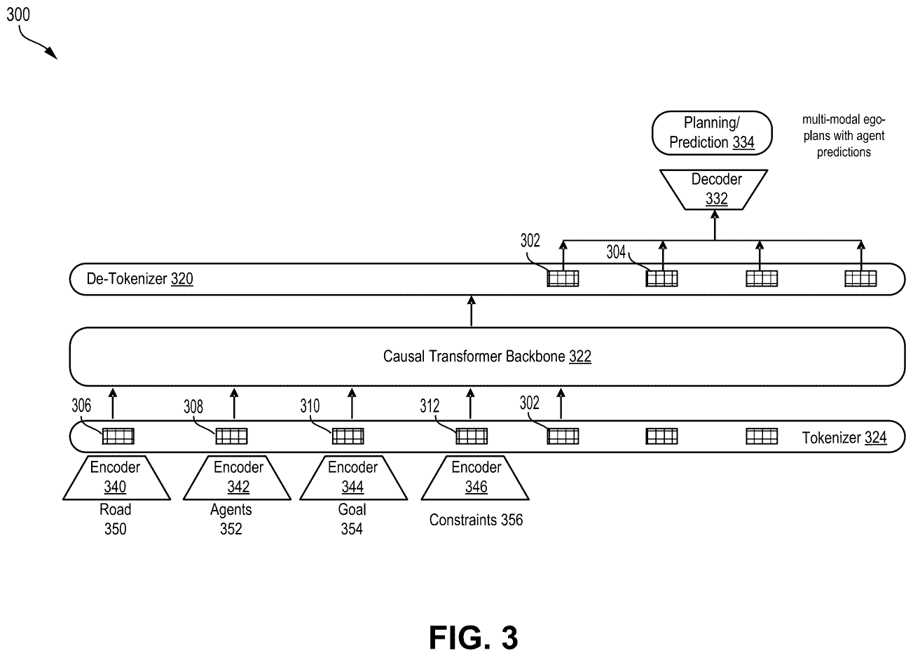

According to various aspects, the planner system 200 provides a data-driven framework. For example, the system 200 can inherently learn the prediction model 210 to be conditioned on the actions of the navigation plan/ego plan. Such an approach allows the planner system 200 to make inherit predictions about future states of agents based on the map and based on current and potential future actions of the ego vehicle. By continuously learning from data, the model can adapt to various driving scenarios and can improve its predictions over time. In some cases, the planner can naturally learn a discrete distribution over action tokens (e.g., when a transformer neural network is used, such as shown in FIG. 3), resulting in an effective framework for encoding uncertainty.

As noted herein, the system 200 is scalable and generalizable. For example, a benefit of the system 200 framework is an ability to scale and generalize with data over time. Unlike traditional systems (e.g., with separate prediction and planning models) that may require additional modes or heuristics to handle new situations, the data-driven approach of the system 200 can naturally extend its capabilities as more data becomes available. Using such an approach allows the planner system 200 to handle a wider range of driving conditions and scenarios without needing manual adjustments or extensive reprogramming.

The planner system 200 can also learn complex human-like behaviors. For example, the system 200 can learn and replicate complex human-like driving behaviors, including nuanced actions such as lateral negotiation around parked cars or yielding to pedestrians at crosswalks. By learning complex behaviors from data rather than relying on explicit rules, the planner system 200 can exhibit more natural and intuitive driving patterns, improving both safety and comfort.

As also noted previously, the system 200 can be designed to provide compute efficiency. For example, the planner system 200 can be designed to distribute computational tasks across various processing units, including CPUs, GPUs, DSP, NPU, NSP, etc. Such distribution of processing across computational resources can help to optimize the use of available hardware resources, reducing overall computational requirements. By efficiently managing compute resources, the system 200 can perform complex calculations and real-time.

FIG. 3 is a block diagram illustrating an example of a system 300 that can be used as a backbone for a planner system (e.g., the planner system 200 of FIG. 2), in accordance with aspects of the present disclosure. System 300 includes a causal transformer backbone 322 that provides an auto-regressive architecture that can scale with additional data.

In the example depicted, various encoders 340, 342, 344, and 346 receive various inputs 350, 352, 354, and 356 respectively, and provide the inputs to tokenizer 324 to generate tokens 306-312. The tokens 306-312 are provided to the causal transformer backbone 322, and the results of which and de-tokenizer 320. The tokens 316 and 318 are provided to decoder 332, the results of which are provided to planning/prediction module 334. The functional blocks depicted in FIG. 3 can be modified as needed for specific architectures.

The system 300 can tokenize inputs 350, 352, 354, and 356, which may include environmental data inputs, including road data, agent data, goal data (e.g., turns, lane changes, etc.), and constraint data, using respective encoder. For example, encoder 340 can process the road data to generate a token 306 representing the road data, encoder 342 can process the agent data to generate a token 308 representing the agent data, encoder 344 can process the goal data to generate a token 310 representing the goal data, and encoder 346 can process the constraint data to generate a token 312 representing the constraint data.

The system 300 can formulate decision making as a next token prediction (e.g., token 302 etc.) by utilizing a transformer architecture. Transformer neural networks are designed to provide scaling and generalization. As noted previously, the transformer backbone provides an auto-regressive backbone architecture to process the tokens 306-312 to generate prediction and/or planning outputs. For instance, only encoder representations (e.g., tokens) may be initially provided to the transformer backbone, then after the initial iteration or after a period of time, output tokens may be provided back into the transformer backbone as inputs.

In one illustrative example, the predicted token 302 can be generated based on processing the tokens 306-312 representing the environmental data inputs. The decoder can process the predicted token 302 to generate a planning and/or prediction output. The predicted token 302 can then be used as input, along with tokens representing the environmental data, in a next iteration of the system 300 to generate the next predicted token. In some cases, the encoders and/or the transformer backbone can be pre-trained with semi-supervised learning techniques aiding in generalization. The architecture of the system 300 is flexible in that goals, constraints, preferences, etc. can be added with minimum modification.

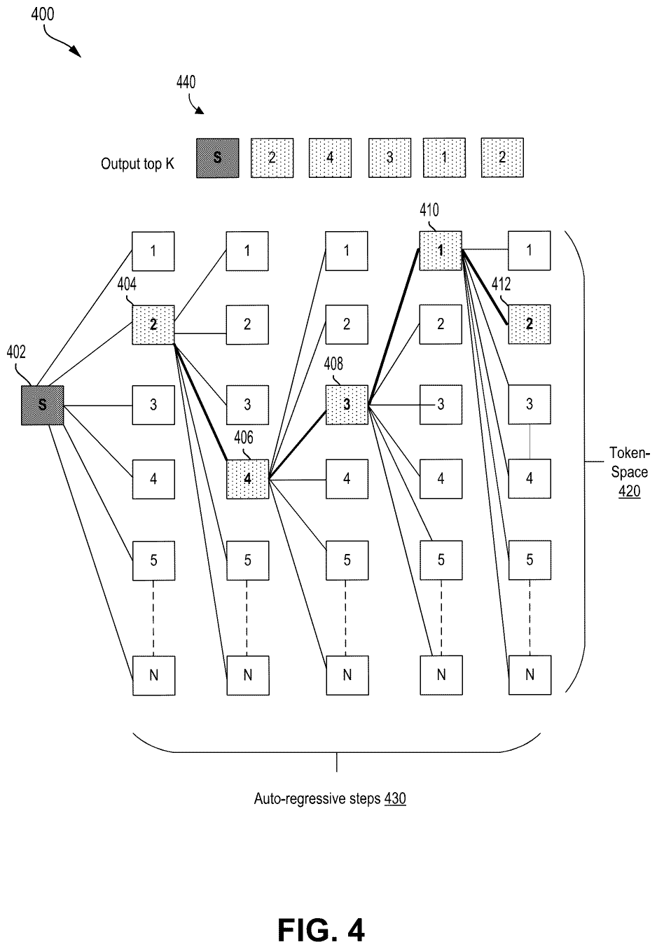

FIG. 4 is a block diagram of a system 400 illustrating autoregressive steps 430 versus token space 420, in accordance with aspects of the present disclosure. For example, each block in the grid may represent a state of a vehicle or a combination of states of a vehicle (e.g., a position of a vehicle in a driving lane, a speed of the vehicle, and/or other state). In the horizontal direction, each pass is a regressive step (e.g., an autoregressive step). In the vertical direction, different states (1... N) are represented. An action represents what the vehicle can do next, such as an acceleration. A trajectory, which includes steps 402, 404, 406, 408, 410, and 412 represents a path that the vehicle may follow. In some cases, a token may represent additional variables such as an action, a trajectory, and so forth.

According to various aspects, a single decision may be equivalent to a tree search, such as a Monte Carlo Tree Search (MCTS). The model depicted in FIG. 4 may internally learn an action-context-goal conditioned transition function. Such a model can support multi-modal output using beam-search, nucleus search, etc. with score. At each autoregressive step, the model is learning the distribution of the token and the state transition which is used to create a final output. As depicted, output 440 represents the trajectory.

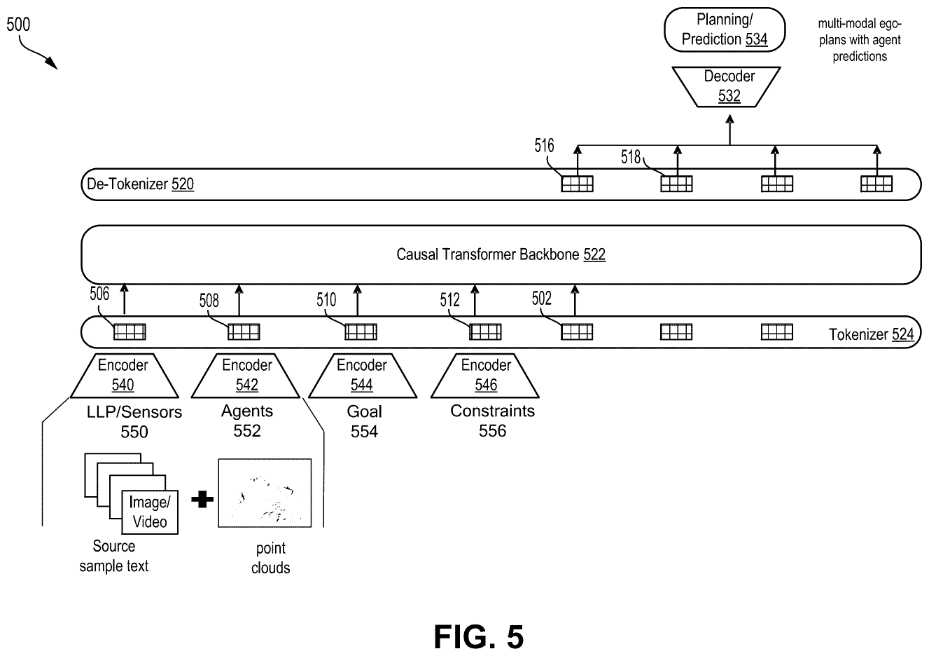

FIG. 5 is a block diagram illustrating a system 500 providing a planner extension that can be used as a backbone for a planner system (e.g., the planner system 200 of FIG. 2), in accordance with aspects of the present disclosure. The example of FIG. 5 illustrates a scalability of the planner system 200 of FIG. 2. For example, vehicle predictions (e.g., ego vehicle predictions) may be output as ground truths, in which case annotations of training data are not needed, allowing unsupervised training techniques to be used.

In the example depicted, various encoders 540, 542, 544, and 546 receive various inputs 550, 552, 554, and 556 respectively, and provide the inputs to tokenizer 524 to generate tokens 506-512. The tokens 506-512 are provided to the causal transformer backbone 522, and the results of which and de-tokenizer 520. The detokenized outputs 516 and 518 are provided to decoder 532, the results of which are provided to planning/prediction module 534. The functional blocks depicted in FIG. 5 can be modified as needed for specific architectures. In one illustrative example, the predicted token 502 can be generated based on processing the tokens 506-512 representing the environmental data inputs. The decoder can process the predicted token 502 to generate a planning and/or prediction output.

The system 500 can tokenize environmental data inputs, including road data, agent data, goal data (e.g., turns, lane changes, etc.), and constraint data, using respective encoder. For example, encoder 540 can process the road data to generate a token 506 representing the road data, encoder 542 can process the agent data to generate a token 508 representing the agent data, encoder 544 can process the goal data to generate a token 510 representing the goal data, and encoder 546 can process the constraint data to generate a token 512 representing the constraint data.

As shown in FIG. 5, additional environment data inputs (relative to those used in the system 300 of FIG. 3) can be processed by the system 500. For example, raw sensor inputs (e.g., images and/or video from one or more image sensors, such as one or more cameras, point clouds based on outputs from one or more LIDAR and/or RADAR sensors, etc.) may be provided as input for processing by the system 500. Similar environment data inputs as those described with respect to the system 300 of FIG. 3 can also be provided as input to the system 500, including road data, agent data, goal data, constraint data, etc. Similar to that described with respect to FIG. 3, encoders can process the environmental data to generate tokens representing the environmental data. The tokens can be provided as input to the transformer backbone. The transformer backbone can output predicted tokens, which can be processed by a decoder to generate one or more planning and/or prediction outputs.

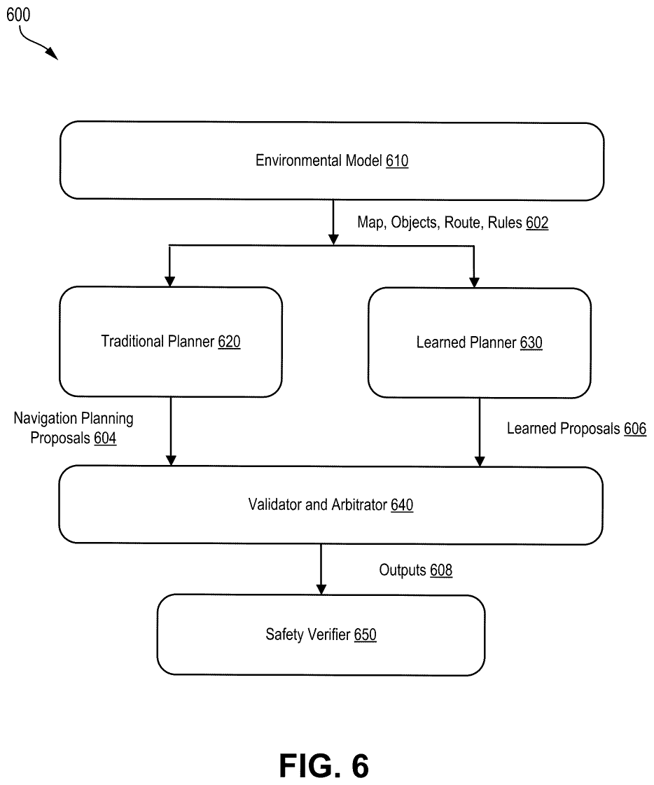

FIG. 6 is a block diagram illustrating an example of a system 600, in accordance with aspects of the present disclosure. As shown, the system 600 includes an environmental model 610, a traditional planner 620 (e.g., including separate prediction and planning models), a learned planner 630 (e.g., the planner system 200 of FIG. 2), a validator and arbitrator 640 (also referred to as an additional model or a validation and arbitration model), and a safety verifier 650.

As shown, perception derived inputs 602 (e.g., environmental data, such as map data, object data, route data, rules, etc.) from the environmental model 610 are provided to the traditional planner 620 and the learned planner 630. The learned planner 630 and the traditional planners 620 coexist and process the inputs in parallel. The traditional planner 620 outputs navigation planning proposals 604 (also referred to as plan proposals) and the learned planner 630 outputs learned navigation planning proposals 606 for the vehicle. The validator and arbitrator 640 provide validation and arbitration of vehicle trajectories using both learned and non-learned costs and constraints, resulting in outputs 608.

Outputs 608 are provided to safety verifier 650, which can select between safety (e.g., Automatic Emergency Braking (AEB)) and comfort functions (e.g., lane changing). Safety verifier 650 (or other models discussed herein) may select between safety and/or comfort functions. Safety and comfort functions work alongside each other. Safety functions are designed to intervene during hazardous situations, such as imminent crashes or a non-responsive driver. By contrast, comfort functions explicitly turned on by driver simply to assist with everyday driving. Safety and comfort functions may be distinguished by implementation, testing, and validation. For instance, safety features demand greater availability, must adhere to higher ASIL standards in both design and documentation, and undergo more rigorous validation.

Examples of safety functions include Autonomous Emergency Braking (AEB), and Minimum Risk Maneuver (MRM). AEB may involve braking for imminent collisions, which usually bypasses a comfort stack for latency and as a guard-rail against miss-detections. AEB and MRM include both lateral and longitudinal maneuvers performed by the safety stack, such as pulling over to the roadside when the driver is unresponsive.

By contrast, examples of comfort functions include smooth longitudinal control or smooth lateral control. Smooth longitudinal control may involve braking proactively for predicted cut-ins or approaching curvature or courteous behaviors such as yielding to pedestrians or avoiding the obstruction of intersections. Smooth lateral control may include making careful in-lane adjustments when traveling next to a large truck, or choosing more comfortable, less aggressive gaps for merges and lane changes. In some cases, safety functions may override comfort functions.

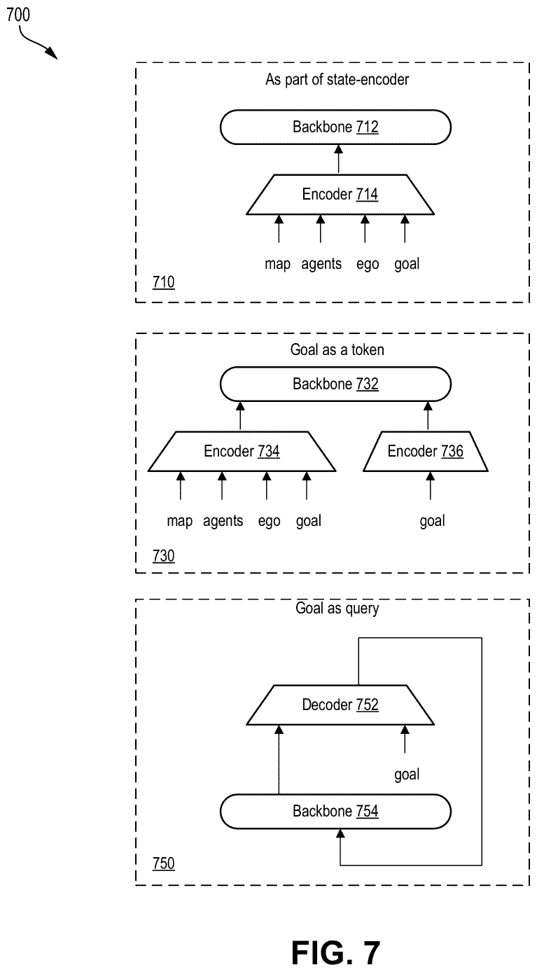

FIG. 7 is a diagram of various examples 700 of systems for illustrating goal conditioning that can be used for the planner systems described herein (e.g., the planner system 200 of FIG. 2), in accordance with aspects of the present disclosure. For example, using goals as an interface can serve to control and guide the behavioral model, providing a simple and scalable abstraction for the system.

As depicted, examples 700 include a first system 710, a second system 730, and third system 750. First system 710 includes various inputs (map, agents, ego, and goal) being provided to an encoder 714, the output of which is provided to a backbone 712. First system 710 represents an in-state encoder.

Second system 730 includes various inputs (map, agents, ego, and goal) being provided to encoder 734 and a goal input being provided to encoder 736. The outputs of encoder 734 and encoder 736 is provided to backbone 732. Second system 730 represents a goal as a token.

Third system 750 represents an improved system in which an output of decoder 752 is provided to backbone 754. An input (goal) is provided, with backbone 754, to decoder 752. Third system 750 represents a goal as a query.

Various scenarios may be represented by goal-conditioning. Examples include, but are not limited to, keeping or maintaining in particular lane, changing lanes, following a split, stopping at a traffic light, turning left or right, yielding, waiting for a turn at a 4-way stop, lane-level guidance, only changing lanes when allowed (e.g., when dotted or dashed lines are present), among others.

One challenge with ML-based approaches is the opacity of decision-making and ensuring that ML models adhere to road and country-specific rules. By using goals as an interface between the higher layer and the AI/ML-based planner systems described herein and by training the planner systems to be goal-compliant, the challenge can be mitigated. Such an approach enhances the interpretability of the planner system.

Various representations of goals and different variations of incorporating goals into the planner system can be used. In addition to enhancing the controllability of the planner system, such an approach reduces the number of inputs the planner system needs to learn, such as traffic lights or interpreting behavior at a 4-way stop. This simplification can increase the model's performance and capacity.

Illustrative examples of how different goals can be utilized to interact with the planner systems described herein (e.g., the planner system 200) include a lane change goal, a stopping for a stop sign goal, and a navigating an intersection goal. With respect to the lane change goal, the target lane and current lane can be defined as goals, allowing the planner to generate multiple trajectories (e.g., one trajectory for lane changing and another trajectory for lane keeping). With respect to the stopping for a stop sign, a goal comprising longitudinal points and/or a virtual stop line can allow the planner to stop. In some cases, upstream models can be used to determine when to start after stopping, which can ensure rule compliance without burdening the learned approach. With respect to the navigating an intersection goal, a lane-level goal can be used to ensure the vehicle (e.g., the ego vehicle) is rule compliant and follows a correct route.

In some aspects, the systems and techniques described herein can use ego-centric tokenization. In general, tokenization is inspired from large language models (LLMs) where most common form of tokenization is byte-pair encoding (BPE). As described herein, in the AI/ML-planner problem setup, environment data inputs such as map, agent history, obstacles, and ego information (e.g., pose of an ego vehicle) can be tokenized in order to improve performance and efficient data representation. Tokenization allows for the use of various input representations, such as symbolic, rasterized, or latent space. This flexibility enables the model to adapt to different types of data and scenarios. Tokenization simplifies the input data, reducing the complexity that the model needs to handle. This can lead to faster training times and more efficient use of computational resources.

With tokenization, models can learn more effectively from the data. By breaking down data into tokens, the model can capture finer details and patterns that might be missed with a more coarse-grained approach. Tokenized models can generalize better to new, unseen data. By learning from tokens, the model can apply its knowledge to a wider range of scenarios, improving its robustness and reliability.

Tokenization schemes can be used in key-point space and trajectory space, where substantial overall improvements can be achieved across metrics. This can be extended to various input spaces, such as map and agents. Uniform bins can be defined as any number of bins and using any positive and/or negative numbers for the bins.

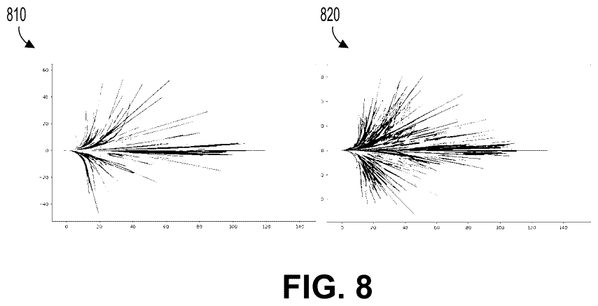

FIG. 8 is a diagram illustrating key-point and trajectory level clustering, in accordance with aspects of the present disclosure. FIG. 8 depicts a first graph 810 and a second graph 820. Second graph 810 represents an improvement relative to graph 810. As depicted, tokenization provides improvements across all metrics. Multiple experiments can be performed with different vocabulary sizes and tokenization schemes.

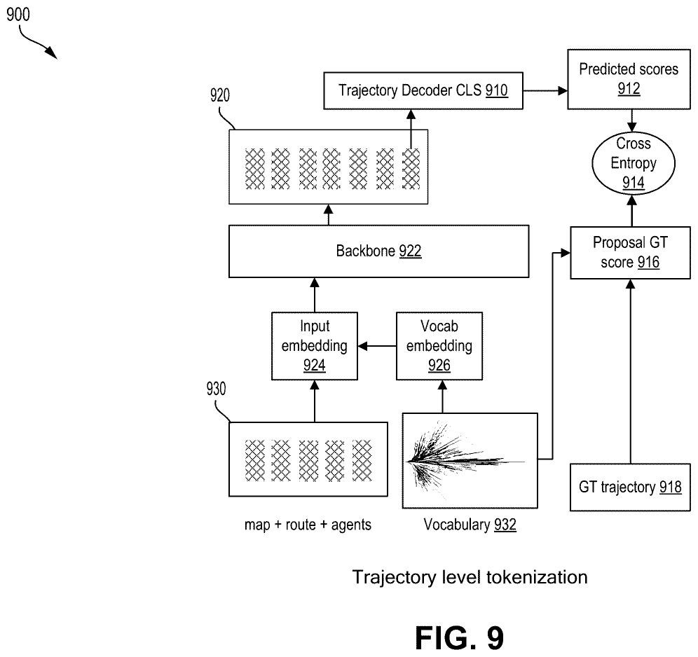

FIG. 9 is a diagram of a system 900 illustrating trajectory classification, in accordance with aspects of the present disclosure. In the example depicted in system 900, various input data is embedded into embedding vectors 930, the outputs of which are provided to input embedding 924. A vocabulary 932 is provided to vocabulary embedding 926 to create an embedding, which is combined with input embedding 924 and provided to backbone 922 to generate embedding vectors 920. Embedding vectors 920 are provided to trajectory decoder 910.

Vocabulary 932 is also provided to a proposal ground truth (GT) score module 916. Proposal GT score module 916 also receives a ground truth trajectory 918 and outputs a score, which is provided to cross entropy module 914 with predicted scores 912 from trajectory decoder 910.

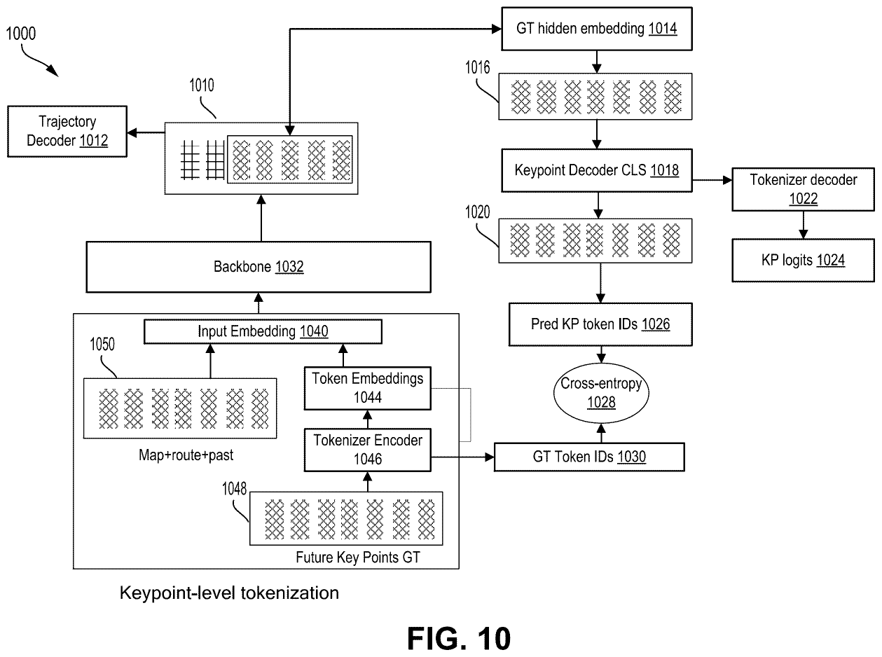

FIG. 10 is a diagram of a system 1000 illustrating key-point level tokenization, in accordance with aspects of the present disclosure. In the example depicted in system 1000, various embedding vectors 1048 are provided to a tokenizer/encoder 1046, which generates token embeddings 1044. A map, route, and past data is provided to generate embedding vectors 1050. Token embeddings 1044 and embedding vectors 1050 are combined to generate an input embedding 1040, which is in turn provided to background 1032.

The embedding vectors 1010 are output from background 1032. Some of the embedding vectors 1010 that represent extracted future keypoint embeddings are provided to trajectory decoder 1012. Keypoint encoding refers to methods in computer vision and machine learning for efficiently representing the spatial information of specific, localized “keypoints” (landmarks) within an image or video. Further, a subset of the embedding vectors 1010 are identified as a ground truth hidden embedding 1014 to generate embedding vectors 1016. Keypoint decoder provides a subset of embeddings to tokenizer/decoder module 1022 and generates KP logits 1024. Additionally, the keypoint decoder CLS module 1018 outputs embedding vectors 1020, which are provided to predicate KP token identifiers 1026 and provided to cross-entropy 1028 with GT token IDs 1030.

Tokenization schemes are typically performed in cartesian coordinate system. The systems and techniques described herein can perform tokenization in Frenet coordinate system. The Frenet coordinate system aligns with the geometry of a road, using longitudinal(s) and lateral (d) coordinates relative to a reference path. Such a representation can make it easier to represent the vehicle's position and movement along the road, simplifying trajectory representation, such as on curved roads or at complex intersections. As described previously, the planner systems described herein is goal conditioned. Further, the goals can be represented with a polyline, which can become a natural reference for the Frenet coordinate system. Such a representation can also allow effective and efficient represent of scene including agents, roads, and history.

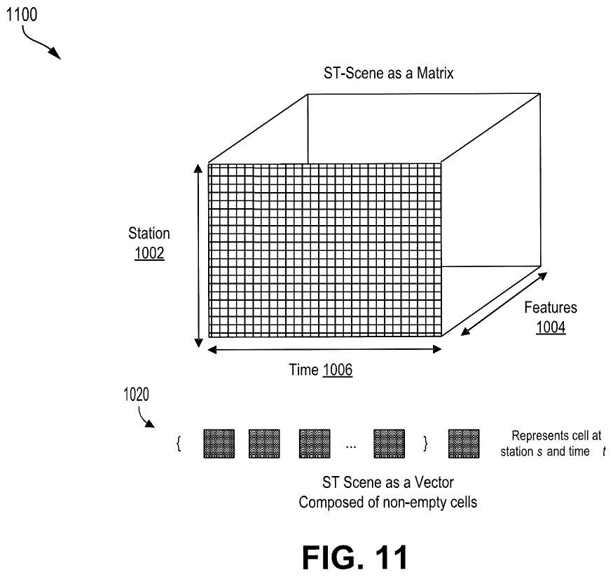

In some cases, a station-time (ST) scene can be used, allowing a lightweight and ego centric way to represent various environmental elements, such as road, occupancy, agents, predictions, and desired goals or queries. FIG. 11 is a diagram illustrating an ST-scene as a matrix and ST-scene as a vector, in accordance with aspects of the present disclosure. The ST-scene representation provides a lightweight ego-centric representation that can be tokenized to represent both inputs and outputs to the AI/ML-based planner systems described herein.

Controllability in the generation process of autoregressive tokenized models refers to the ability to guide and influence the output of the model based on specific conditions or inputs, constraints, or specific design patterns. Controllability can provide an interface to guide the trajectory output during inference.

In the planning system architectures described herein, key-points can be generated autoregressively, while the trajectory generator can use these key-points along with hidden latent context as inputs (e.g., as described with respect to the system 300 of FIG. 3 and/or the system 500 of FIG. 5). This setup allows the key-points to be influenced during both sampling and post-processing. In some cases, the systems and techniques described herein provide a method of influencing key-points to create trajectories that comply with user requirements and adhere to established rules. For example, a trajectory can be influenced through (but not limited to): (1) Road rule violation (key-points that violate road constraints can be detected and corrected during generation to ensure the final trajectory complies with road rules); (2) Mode violation (the goal input is lane-compliant, providing lane-level guidance for modes such as lane-keeping, turning, and following a split. The planner system can detect and correct mode violations to ensure goal-compliant trajectories and limit compounding errors in the autoregressive sampling process.) and (3) Token-selection (Different tokens from the same sampling step can be chosen to meet high-level constraints, such as ‘maintaining a certain distance from a bike lane’.)

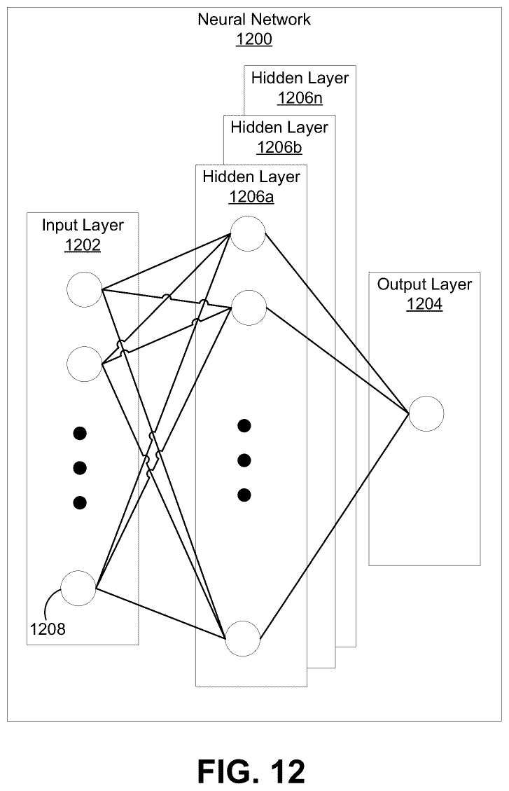

FIG. 11 is a diagram illustrating scenes 1100 as a matrix and as a vector, in accordance with aspects of the present disclosure. Scenes 1100 are plotted on an first axis (station) 1002, features (1004), and time (1006). Output vector 1020 depicts the scene as a vector composed of non-empty cells. As described herein, the planner systems described herein can utilize one or more machine learning models (e.g., one or more neural networks). FIG. 12 is an illustrative example of a neural network 1200 (e.g., a deep-learning neural network) that can be used to implement a machine-learning-based planner system. For example, neural network 1200 may be an example of, or can implement, a generative machine-learning model.

Neural network 1200 includes multiple hidden layers hidden layers 1206a, 1206b, through 1206n. The hidden layers 1206a, 1206b, through hidden layer 1206n include “n” number of hidden layers, where “n” is an integer greater than or equal to one. The number of hidden layers can be made to include as many layers as needed for the given application. Neural network 1200 further includes an output layer 1204 that provides an output resulting from the processing performed by the hidden layers 1206a, 1206b, through 1206n.

Neural network 1200 may be, or may include, a multi-layer neural network of interconnected nodes. Each node can represent a piece of information. Information associated with the nodes is shared among the different layers and each layer retains information as information is processed. In some cases, neural network 1200 can include a feed-forward network 1314, in which case there are no feedback connections where outputs of the network are fed back into itself. In some cases, neural network 1200 can include a recurrent neural network, which can have loops that allow information to be carried across nodes while reading in input.

Information can be exchanged between nodes through node-to-node interconnections between the various layers. Nodes of input layer 1202 can activate a set of nodes in the first hidden layer 1206a. For example, as shown, each of the input nodes of input layer 1202 is connected to each of the nodes of the first hidden layer 1206a. The nodes of first hidden layer 1206a can transform the information of each input node by applying activation functions to the input node information. The information derived from the transformation can then be passed to and can activate the nodes of the next hidden layer 1206b, which can perform their own designated functions. Example functions include convolutional, up-sampling, data transformation, and/or any other suitable functions. The output of the hidden layer 1206b can then activate nodes of the next hidden layer, and so on. The output of the last hidden layer 1206n can activate one or more nodes of the output layer 1204, at which an output is provided. In some cases, while nodes (e.g., node 1208) in neural network 1200 are shown as having multiple output lines, a node has a single output and all lines shown as being output from a node represent the same output value.

In some cases, each node or interconnection between nodes can have a weight that is a set of parameters derived from the training of neural network 1200. Once neural network 1200 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1200 to be adaptive to inputs and able to learn as more and more data is processed.

Neural network 1200 may be pre-trained to process the features from the data in the input layer 1202 using the different hidden layers 1206a, 1206b, through 1206n in order to provide the output through the output layer 1204. In an example in which neural network 1200 is used to identify features in images, neural network 1200 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1200 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 1200 is trained well enough so that the weights of the layers are accurately tuned.

For the example of identifying objects in images, the forward pass can include passing a training image through neural network 1200. The weights are initially randomized before neural network 1200 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1200, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1200 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1200 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and denotes a learning rate. The learning rate can be set to any suitable value, with a high learning rate including larger weight updates and a lower value indicating smaller weight updates.

Neural network 1200 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1200 can include any other deep network other than a CNN, such as an autoencoder, a deep belief nets (DBNs), a Recurrent Neural Networks (RNNs), among others.

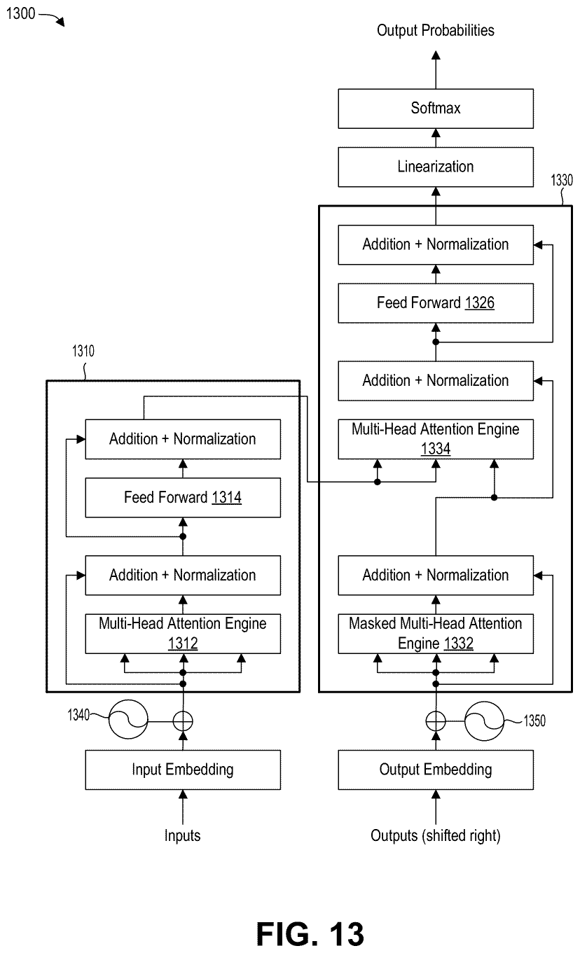

FIG. 13 is a block diagram of an example transformer in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. A transformer 1300 reduces the operations of learning dependencies by using an encoder 1310 and a decoder 1330 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1310 is composed of a stack of six identical layers and each layer has two sub-layers. The first sub-layer is a multi-head self-attention engine 1312, and the second sub-layer is a fully connected feed-forward network 1314. A residual connection (not shown) connects around each of the sub-layers followed by normalization.

In this example transformer 1300, the decoder 1330 is also composed of a stack of six identical layers. The decoder also includes a masked multi-head self-attention engine 1332, a multi-head attention engine 1334 over the output of the encoder 1310, and a fully connected feed-forward network 1326. Each layer includes a residual connection (not shown) around the layer, which is followed by layer normalization. The masked multi-head self-attention engine 1332 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1340 to encode positions because the model does not contain recurrence and convolution and relative or absolute position of the tokens is needed. In the transformer 1300, the positional encodings are added to the input embeddings at the bottom layer of the encoder 1310 and the decoder 1330. The positional encodings are summed with the embeddings because the positional encodings and embeddings have the same dimensions. A corresponding position decoder 1350 is configured to decode the positions of the embeddings for the decoder 1330.

In some aspects, the transformer 1300 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1300 can process input sequences of variable length, making it well-suited for natural language processing tasks where input lengths can vary greatly. Additionally, the self-attention mechanism allows the transformer 1300 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

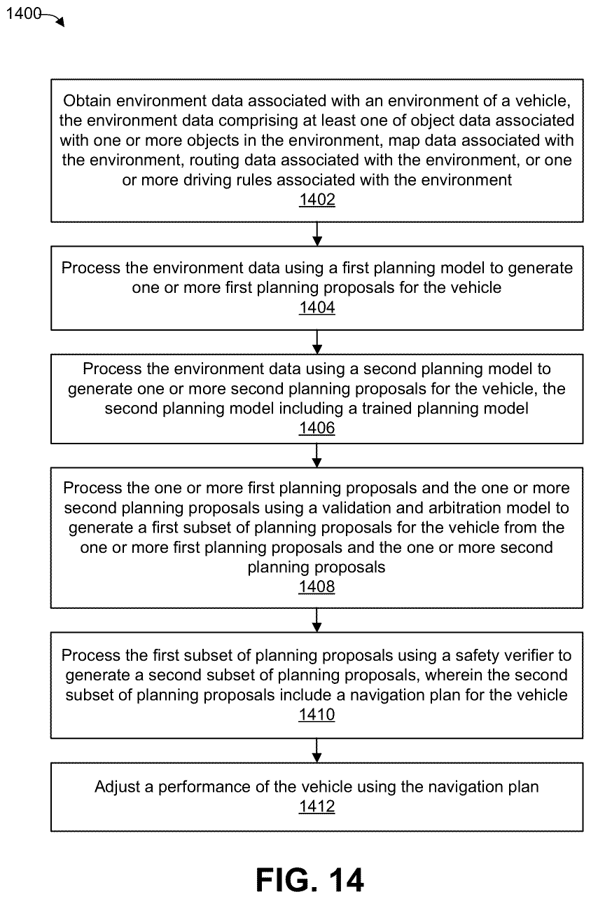

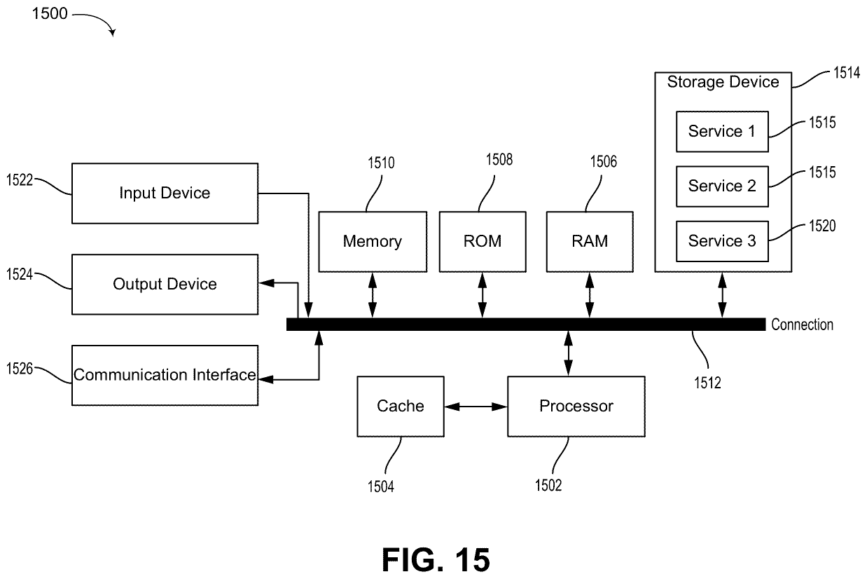

FIG. 14 is a flow diagram illustrating an example of a process 1400 for generating image content is provided. According to aspects described herein, the process 1400 can be performed by a computing device (e.g., the vehicle 100 of FIG. 1A and/or FIG. 1B, the system 150 of FIG. 1C or a computing device including the system 150, the SOC 105 of FIG. 1D or a computing device including the SOC 105, a computing device including the planner system 200 of FIG. 2, a computing device or computing device architecture 1500 of FIG. 15, etc.) or by a component or system (e.g., a component of the vehicle 100 of FIG. 1A and/or FIG. 1B, the system 150 of FIG. 1C or a component thereof, the planner system 200 of FIG. 2, a chipset, one or more processors central processing units (CPUs), digital signal processors (DSPs), graphics processing units (GPUs), one or more neural processing units (NPUs), one or more neural signal processors (NSPs), any other type of processor(s), any combination thereof, the computing device architecture 1500 of FIG. 15 or component thereof, or other component or system) of the computing device. The operations of the process 1400 can be implemented as software components that are executed and run on one or more processors (e.g., processor 1502 of FIG. 15 or other processor(s)) of the computing device. Further, the transmission and reception of signals by the computing device in the process 1400 can be enabled, for example, by one or more antennas and/or one or more transceivers (e.g., wireless transceiver(s)).

At block 1402, the computing device (or component thereof) can obtain environment data associated with an environment of a vehicle, the environment data including object data associated with one or more objects in the environment, map data associated with the environment, routing data associated with the environment, one or more driving rules associated with the environment, any combination thereof, and/or other data or information. In some aspects, the object data is based on input from one or more sensors of the vehicle, such as one or more image sensors (e.g., cameras), LIDAR sensors, RADAR sensors, and/or other sensors that can capture or otherwise obtain sensor data (e.g., one or more images, LIDAR data, RADAR data, etc.). In some case, the object data is derived from the input (e.g., a point cloud derived from LIDAR and/or RADAR sensor data, one or more embeddings generated based on the sensor data, etc.).

At block 1404, the computing device (or component thereof) can process the environment data using a first planning model to generate one or more first planning proposals for the vehicle. At block 1406, the computing device (or component thereof) can process the environment data using a second planning model to generate one or more second planning proposals for the vehicle. The second planning model includes a trained planning model. For instance, in some cases, the first planning model can include separate prediction and planning models (e.g., the traditional planner of FIG. 6), similar to the traditional driving systems described above). For instance, in some aspects, the first planning model uses an algorithmic approach to generate the one or more first planning proposals. In some cases, the second planning model (e.g., the trained planning model) can include the planner system 200 of FIG. 2 and/or the learned planner of FIG. 6. For example, in some aspects, the second planning model (e.g., the trained planning model) is a machine learning model. In some examples, the machine learning model is or includes a transformer network (e.g., the transformer backbone of FIG. 3 and/or FIG. 5) that is configured to process the environment data as one or more tokens. In some cases, the transformer network is trained to be goal compliant as described herein. In some examples, the transformer network uses at least one of key-point level tokenization or trajectory level tokenization.

At block 1408, the computing device (or component thereof) can process the one or more first planning proposals and the one or more second planning proposals using an additional model (e.g., a validation and arbitration model such as the validator and arbitrator of FIG. 6) to generate a first subset of planning proposals for the vehicle from the one or more first planning proposals and the one or more second planning proposals. In some aspects, to process the one or more first planning proposals and the one or more second planning proposals using the additional model, the computing device (or component thereof) can validate one or more trajectories based on learned and non-learned costs and constraints.

At block 1410, the computing device (or component thereof) can process the first subset of planning proposals using a safety verifier (e.g., the safety verifier of FIG. 6) to generate a second subset of planning proposals. The second subset of planning proposals include a navigation plan for the vehicle. In some aspects, to process the first subset of planning proposals using the safety verifier, the computing device (or component thereof) can select between safety and comfort functions. In some aspects, the first planning model, the second planning model, the additional model, and/or the safety verifier are configured to accept vectorized, rasterized, and/or latent inputs (e.g., embedding vectors, feature vectors, etc.).

At block 1412, the computing device (or component thereof) can adjust a performance of the vehicle using the navigation plan. In some aspects, the one or more first planning proposals and/or the one or more second planning proposals include predictions of movements of one or more objects represented in the object data. In some aspects, the computing device (or component thereof) can output the predictions on a display.

In some cases, the devices or apparatuses configured to perform the operations of the process 1400 and/or other processes described herein may include a processor, microprocessor, microcomputer, or other component of a device that is configured to carry out the steps of the process 1400 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 1400 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1400 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 1400 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

FIG. 15 illustrates an example computing-device architecture 1500 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1500 may include, implement, or be included in any or all of vehicle 100. Additionally or alternatively, computing-device architecture 1500 may be configured to perform process 1400, and/or other process described herein.

The components of computing-device architecture 1500 are shown in electrical communication with each other using connection 1512, such as a bus. The example computing-device architecture 1500 includes a processing unit (CPU or processor) 1502 and computing device connection 1512 that couples various computing device components including computing device memory 1510, such as read only memory (ROM) 1508 and random-access memory (RAM) 1506, to processor 1502.

Computing-device architecture 1500 can include a cache of high-speed memory connected directly with, in close proximity to, or integrated as part of processor 1502. Computing-device architecture 1500 can copy data from memory 1510 and/or the storage device 1514 to cache 1504 for quick access by processor 1502. In this way, the cache can provide a performance boost that avoids processor 1502 delays while waiting for data. These and other models can control or be configured to control processor 1502 to perform various actions. Other computing device memory 1510 may be available for use as well. Memory 1510 can include multiple different types of memory with different performance characteristics. Processor 1502 can include any general-purpose processor and a hardware or software service, such as service 1 1515, service 2 1515, and service 3 1520 stored in storage device 1514, configured to control processor 1502 as well as a special-purpose processor where software instructions are incorporated into the processor design. Processor 1502 may be a self-contained system, containing multiple cores or processors, a bus, memory controller, cache, etc. A multi-core processor may be symmetric or asymmetric.

To enable user interaction with the computing-device architecture 1500, input device 1522 can represent any number of input mechanisms, such as a microphone for speech, a touch-sensitive screen for gesture or graphical input, keyboard, mouse, motion input, speech and so forth. Output device 1524 can also be one or more of a number of output mechanisms known to those of skill in the art, such as a display, projector, television, speaker device, etc. In some instances, multimodal computing devices can enable a user to provide multiple types of input to communicate with computing-device architecture 1500. Communication interface 1526 can generally govern and manage the user input and computing device output. There is no restriction on operating on any particular hardware arrangement and therefore the basic features here may easily be substituted for improved hardware or firmware arrangements as they are developed.

Storage device 1514 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1506, read only memory (ROM) 1508, and hybrids thereof. Storage device 1514 can include services 1515, 1515, and 1520 for controlling processor 1502. Other hardware or software models are contemplated. Storage device 1514 can be connected to the computing device connection 1512. In one aspect, a hardware model that performs a particular function can include the software component stored in a computer-readable medium in connection with the necessary hardware components, such as processor 1502, connection 1512, output device 1524, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for autonomous driving, comprising: at least one memory; and at least one processor coupled to the at least one memory and configured to: obtain environment data associated with an environment of a vehicle, the environment data comprising at least one of object data associated with one or more objects in the environment, map data associated with the environment, routing data associated with the environment, or one or more driving rules associated with the environment; process the environment data using a first planning model to generate one or more first planning proposals for the vehicle; process the environment data using a second planning model to generate one or more second planning proposals for the vehicle, the second planning model including a trained planning model; process the one or more first planning proposals and the one or more second planning proposals using a additional model to generate a first subset of planning proposals for the vehicle from the one or more first planning proposals and the one or more second planning proposals; process the first subset of planning proposals using a safety verifier to generate a second subset of planning proposals, wherein the second subset of planning proposals include a navigation plan for the vehicle; and adjust a performance of the vehicle using the navigation plan.
Aspect 2. The apparatus of Aspect 1, wherein the object data is based on input from one or more sensors of the vehicle.
Aspect 3. The apparatus of Aspect 2, wherein the object data is derived from the input.
Aspect 4. The apparatus of any of Aspects 1 to 3, wherein the first planning model uses an algorithmic approach to generate the one or more first planning proposals.
Aspect 5. The apparatus of any of Aspects 1 to 4, wherein the second planning model comprises a transformer network that is configured to process the environment data as one or more tokens.
Aspect 6. The apparatus of Aspect 5, wherein the transformer network is trained to be goal compliant.
Aspect 7. The apparatus of any of Aspects 5 or 6, wherein the transformer network uses at least one of key-point level tokenization or trajectory level tokenization.
Aspect 8. The apparatus of any of Aspects 1 to 7, wherein, to process the one or more first planning proposals and the one or more second planning proposals using the additional model, the at least one processor is configured to validate one or more trajectories based on learned and non-learned costs and constraints.
Aspect 9. The apparatus of any of Aspects 1 to 8, wherein, to process the first subset of planning proposals using the safety verifier, the at least one processor is configured to select between safety and comfort functions.
Aspect 10. The apparatus of any of Aspects 1 to 9, wherein at least one of the first planning model, the second planning model, the additional model, or the safety verifier are configured to accept vectorized, rasterized, and/or latent inputs.
Aspect 11. The apparatus of any of Aspects 1 to 10, wherein at least one of the one or more first planning proposals or the one or more second planning proposals are based on predictions of movements of one or more objects represented in the object data.
Aspect 12. The apparatus of Aspect 11, wherein the at least one processor is configured to output the predictions on a display.
Aspect 13. The apparatus of any of Aspects 1 to 12, wherein the trained planning model is a machine learning model.
Aspect 14. The apparatus of any of Aspects 1 to 12, wherein the additional model is a validation or an arbitration model.
Aspect 15. A method for autonomous driving, comprising: obtaining environment data associated with an environment of a vehicle, the environment data comprising at least one of object data associated with one or more objects in the environment, map data associated with the environment, routing data associated with the environment, or one or more driving rules associated with the environment; processing the environment data using a first planning model to generate one or more first planning proposals for the vehicle; processing the environment data using a second planning model to generate one or more second planning proposals for the vehicle, the second planning model including a trained planning model; processing the one or more first planning proposals and the one or more second planning proposals using an additional model to generate a first subset of planning proposals for the vehicle from the one or more first planning proposals and the one or more second planning proposals; processing the first subset of planning proposals using a safety verifier to generate a second subset of planning proposals, wherein the second subset of planning proposals include a navigation plan for the vehicle; and adjusting a performance of the vehicle using the navigation plan.
Aspect 16. The method of Aspect 15, wherein the object data is based on input from one or more sensors of the vehicle.
Aspect 17. The method of Aspect 16, wherein the object data is derived from the input.
Aspect 18. The method of any of Aspects 15 to 17, wherein the first planning model uses an algorithmic approach to generate the one or more first planning proposals.
Aspect 19. The method of any of Aspects 15 to 18, wherein the second planning model comprises a transformer network that is configured to process the environment data as one or more tokens.
Aspect 20. The method of Aspect 19, wherein the transformer network is trained to be goal compliant.
Aspect 21. The method of any of Aspects 19 or 20, wherein the transformer network uses at least one of key-point level tokenization or trajectory level tokenization.
Aspect 22. The method of any of Aspects 15 to 20, wherein processing the one or more first planning proposals and the one or more second planning proposals using the additional model comprises validating one or more trajectories based on learned and non-learned costs and constraints.
Aspect 23. The method of any of Aspects 15 to 22, wherein processing the first subset of planning proposals using the safety verifier comprises selecting between safety and comfort functions.
Aspect 24. The method of any of Aspects 16 to 23, wherein at least one of the first planning model, the second planning model, the additional model, or the safety verifier are configured to accept vectorized, rasterized, and/or latent inputs.
Aspect 25. The method of any of Aspects 16 to 24, wherein at least one of the one or more first planning proposals or the one or more second are based on predictions of movements of one or more objects represented in the object data.
Aspect 26. The method of Aspect 25, further comprising outputting the predictions on a display.
Aspect 27. The method of any of Aspects 15 to 26, wherein the trained planning model is a machine learning model.
Aspect 28. The apparatus of any of Aspects 15 to 27, wherein the additional model is a validation or an arbitration model.
Aspect 29. A non-transitory computer-readable medium having stored thereon instructions that, when executed by at least one processor, cause the at least one processor to perform operations according to any of Aspects 15 to 27.
Aspect 30. An apparatus for autonomous driving, the apparatus including one or more means for performing operations according to any of Aspects 15 to 27.

What is claimed is:

1. An apparatus for autonomous driving, comprising:
at least one memory; and
at least one processor coupled to the at least one memory and configured to: obtain environment data associated with an environment of a vehicle, the environment data comprising at least one of object data associated with one or more objects in the environment, map data associated with the environment, routing data associated with the environment, or one or more driving rules associated with the environment;
process the environment data using a first planning model to generate one or more first planning proposals for the vehicle;
process the environment data using a second planning model to generate one or more second planning proposals for the vehicle, the second planning model including a trained planning model;
process the one or more first planning proposals and the one or more second planning proposals using an additional model to generate a first subset of planning proposals for the vehicle from the one or more first planning proposals and the one or more second planning proposals;
process the first subset of planning proposals using a safety verifier to generate a second subset of planning proposals, wherein the second subset of planning proposals include a navigation plan for the vehicle; and
adjust a performance of the vehicle using the navigation plan.

2. The apparatus of claim 1, wherein the object data is based on input from one or more sensors of the vehicle.

3. The apparatus of claim 2, wherein the object data is derived from the input.

4. The apparatus of claim 1, wherein the first planning model uses an algorithmic approach to generate the one or more first planning proposals.

5. The apparatus of claim 1, wherein the second planning model comprises a transformer network that is configured to process the environment data as one or more tokens.

6. The apparatus of claim 5, wherein the transformer network uses at least one of key-point level tokenization or trajectory level tokenization.

7. The apparatus of claim 1, wherein, to process the one or more first planning proposals and the one or more second planning proposals using the additional model, the at least one processor is configured to validate one or more trajectories based on learned and non-learned costs and constraints.

8. The apparatus of claim 1, wherein, to process the first subset of planning proposals using the safety verifier, the at least one processor is configured to select between safety and comfort functions.

9. The apparatus of claim 1, wherein at least one of the first planning model, the second planning model, the additional model, or the safety verifier are configured to accept one or more of vectorized, rasterized, or latent inputs.

10. The apparatus of claim 1, wherein at least one of the one or more first planning proposals or the one or more second planning proposals are based on predictions of movements of one or more objects represented in the object data.

11. The apparatus of claim 10, wherein the at least one processor is configured to output the predictions on a display.

12. A method for autonomous driving, comprising:
obtaining environment data associated with an environment of a vehicle, the environment data comprising at least one of object data associated with one or more objects in the environment, map data associated with the environment, routing data associated with the environment, or one or more driving rules associated with the environment;
processing the environment data using a first planning model to generate one or more first planning proposals for the vehicle;
processing the environment data using a second planning model to generate one or more second planning proposals for the vehicle, the second planning model including a trained planning model;
processing the one or more first planning proposals and the one or more second planning proposals using an additional model to generate a first subset of planning proposals for the vehicle from the one or more first planning proposals and the one or more second planning proposals;
processing the first subset of planning proposals using a safety verifier to generate a second subset of planning proposals, wherein the second subset of planning proposals include a navigation plan for the vehicle; and
adjusting a performance of the vehicle using the navigation plan.

13. The method of claim 12, wherein the first planning model uses an algorithmic approach to generate the one or more first planning proposals.

14. The method of claim 12, wherein the second planning model comprises a transformer network that is configured to process the environment data as one or more tokens.

15. The method of claim 14, wherein the transformer network is trained to be goal compliant and uses at least one of key-point level tokenization or trajectory level tokenization.

16. The method of claim 12, wherein processing the one or more first planning proposals and the one or more second planning proposals using the additional model comprises validating one or more trajectories based on learned and non-learned costs and constraints.

17. The method of claim 12, wherein processing the first subset of planning proposals using the safety verifier comprises selecting between safety and comfort functions.

18. The method of claim 12, wherein at least one of the first planning model, the second planning model, the additional model, or the safety verifier are configured to accept vectorized, rasterized, and/or latent inputs.

19. The method of claim 12, wherein at least one of the one or more first planning proposals or the one or more second planning proposals comprise predictions of movements of one or more objects represented in the object data.

20. A non-transitory computer-readable medium is provided that has stored thereon instructions that, when executed by one or more processors, cause the one or more processors to:
obtain environment data associated with an environment of a vehicle, the environment data comprising at least one of object data associated with one or more objects in the environment, map data associated with the environment, routing data associated with the environment, or one or more driving rules associated with the environment;
process the environment data using a first planning model to generate one or more first planning proposals for the vehicle;
process the environment data using a second planning model to generate one or more second planning proposals for the vehicle, the second planning model including a trained planning model;
process the one or more first planning proposals and the one or more second planning proposals using an additional model to generate a first subset of planning proposals for the vehicle from the one or more first planning proposals and the one or more second planning proposals;
process the first subset of planning proposals using a safety verifier to generate a second subset of planning proposals, wherein the second subset of planning proposals include a navigation plan for the vehicle; and
adjust a performance of the vehicle using the navigation plan.
